(19) United States
(12) Patent Application Publication
(10) Pub. No.: US 2025/0104232 A1
(43) Pub. Date: Mar. 27, 2025

(54) OCCLUSION DETECTION METHOD FOR MEDICAL IMAGING, AND MEDICAL IMAGING METHOD AND SYSTEM

(71) Applicant: GE Precision Healthcare LLC, Waukesha, WI (US)

(72) Inventors: Ting Ye, Beijing (CN); Qingyu Dai, Beijing (CN); Xiaolan Liu, Beijing (CN); Hao Yang, Beijing (CN); Jian Cui, Beijing (CN); Ke Li, Beijing (CN)

(21) Appl. No.: 18/889,322

(22) Filed: Sep. 18, 2024

(30) Foreign Application Priority Data
Sep. 21, 2023 (CN) 202311227799.3

(51) Int. Cl. G06T 7/00; G06T 7/33

(52) U.S. Cl. CPC G06T 7/0012; G06T 7/337; G06T 2207/20081

(57) ABSTRACT

Provided in embodiments of the present application are an occlusion detection method for medical imaging, a medical imaging method, and a medical imaging system. The occlusion detection method for medical imaging includes: acquiring an image sequence, the image sequence including a plurality of images of an object in a time dimension; and according to at least one among confidence level change information and depth change information of a keypoint of the object in the plurality of images, determining an occlusion state of the keypoint.

### CROSS REFERENCE TO RELATED APPLICATIONS

The present application claims priority and benefit of Chinese Patent Application No. 202311227799.3 filed on Sep. 21, 2023, which is incorporated herein by reference in its entirety.

### TECHNICAL FIELD

Embodiments of the present application relate to the technical field of medical devices, and in particular to an occlusion detection method for medical imaging, and a medical imaging method and system.

### BACKGROUND

In a scenario where a medical imaging system is used to scan and image an object under detection, positioning information of the object can be determined based on an image of the object acquired by a camera apparatus so as to position the object under detection. In positioning operation processes, it is necessary to determine whether the surface of the object under detection is covered with an occlusion (e.g., a coil, a blanket, complex clothing, a mask, and the like).

### SUMMARY

Embodiments of the present application provide an occlusion detection method for medical imaging, and a medical imaging method and system.

According to one aspect of the embodiments of the present application, an occlusion detection method for medical imaging is provided. The method comprises: acquiring an image sequence, the image sequence comprising a plurality of images of an object in a time dimension; and according to at least one among confidence level change information and depth change information of a keypoint of the object in the plurality of images, determining an occlusion state of the keypoint.

According to one aspect of the embodiments of the present application, a medical imaging method is provided. The method comprises: determining an occlusion state of a keypoint on the basis of the foregoing occlusion detection method for medical imaging; determining positioning information of an object according to the occlusion state of the keypoint; and performing a scanning operation according to the determined positioning information.

According to one aspect of the embodiments of the present application, a medical imaging system is provided. The system comprises: a controller, configured to perform the foregoing occlusion detection method for medical imaging to determine an occlusion state of a keypoint, and to determine positioning information of an object according to the occlusion state of the keypoint; and a scanning assembly, which performs a scanning operation according to the determined positioning information.

One of the beneficial effects of the embodiments of the present application is that: according to at least one among confidence level change information and depth change information of a keypoint in a plurality of images in an image sequence, an occlusion state of the keypoint is determined, thereby improving the accuracy and reliability of the occlusion state. In addition, the foregoing manner of determining the occlusion state does not depend on the shape, color, pattern, or the like of an occlusion, and has wide applicability.

With reference to the following description and drawings, specific implementations of the embodiments of the present application are disclosed in detail, and the means by which the principles of the embodiments of the present application can be employed are illustrated. It should be understood that the implementations of the present application are not limited in scope thereby. Within the scope of the spirit and clauses of the appended claims, the implementations of the present application include many changes, modifications, and equivalents.

### BRIEF DESCRIPTION OF THE DRAWINGS

The included drawings are used to provide further understanding of the embodiments of the present application, which constitute a part of the description and are used to illustrate the implementations of the present application and explain the principles of the present application together with textual description. Evidently, the drawings in the following description are merely some embodiments of the present application, and a person of ordinary skill in the art may obtain other implementations according to the drawings without involving inventive effort. In the drawings:

FIG. 1 is a schematic diagram of a magnetic resonance imaging system according to an embodiment of the present application;

FIG. 2 is a schematic diagram of an occlusion detection method for medical imaging according to an embodiment of the present application;

FIG. 3 is a schematic diagram of keypoints according to an embodiment of the present application;

FIG. 4 is a schematic diagram of the occlusion state of keypoints according to an embodiment of the present application;

FIG. 5 is another schematic diagram of the occlusion state of keypoints according to an embodiment of the present application;

FIG. 6 is a schematic diagram of a preset region according to an embodiment of the present application;

FIG. 7 is a schematic diagram of the implementation of step 202 according to an embodiment of the present application;

FIG. 8 is an occlusion detection apparatus for medical imaging according to an embodiment of the present application; and

FIG. 9 is a schematic diagram of a medical imaging method according to an embodiment of the present application.

### DETAILED DESCRIPTION

The foregoing and other features of the embodiments of the present application will become apparent from the following description with reference to the drawings. In the description and drawings, specific implementations of the present application are disclosed in detail, and part of the implementations in which the principles of the embodiments of the present application may be employed are indicated. It should be understood that the present application is not limited to the described implementations. On the contrary, the embodiments of the present application include all modifications, variations, and equivalents which fall within the scope of the appended claims.

In the embodiments of the present application, the terms “first”, “second” and so on are used to distinguish different elements, but do not represent a spatial arrangement or a temporal order, etc., of these elements, and these elements should not be limited by these terms. The term “and/or” includes any and all combinations of one or more associated listed terms. The terms “comprise”, “include”, “have”, etc., refer to the presence of described features, elements, components, or assemblies, but do not exclude the presence or addition of one or more other features, elements, components, or assemblies.

In the embodiments of the present application, the singular forms “a” and “the”, etc., include plural forms, and should be broadly construed as “a type of” or “a class of” rather than being limited to the meaning of “one”. Furthermore, the term “the” should be construed as including both the singular and plural forms, unless otherwise specified in the context. In addition, the term “according to” should be construed as “at least in part according to . . . ” and the term “on the basis of” should be construed as “at least in part on the basis of . . . ”, unless otherwise specified in the context.

In the embodiments of the present application, the term “landmark” may be equivalently replaced with “keypoint”, “key coordinate point”, or “landmark point”. The term “object” may be equivalently replaced with “object under detection”, “scan object”, “object to be scanned”, “patient”, “object being studied”, which may be a human being or an animal, or the like.

In the embodiments of the present application, the term “include/comprise” when used herein refers to the presence of features, integrated components, steps, or assemblies, but does not preclude the presence or addition of one or more other features, integrated components, steps, or assemblies.

The features described and/or illustrated for one implementation may be used in one or more other implementations in the same or similar manner, be combined with features in other embodiments, or replace features in other implementations.

The occlusion detection method according to the embodiments of the present application may be applicable to various medical imaging scenarios, including but not limited to, magnetic resonance imaging (MRI), computed tomography (CT), ultrasound imaging, positron emission computed tomography (PET), single photon emission computed tomography (SPECT), PET/CT, PET/MR, or any other suitable medical imaging scenarios.

In the embodiments of the present application, the method, apparatus and system of the present application are exemplarily described by taking an MRI scenario as an example. It should be understood that the features of the embodiments of the present application are also applicable to other medical imaging scenarios.

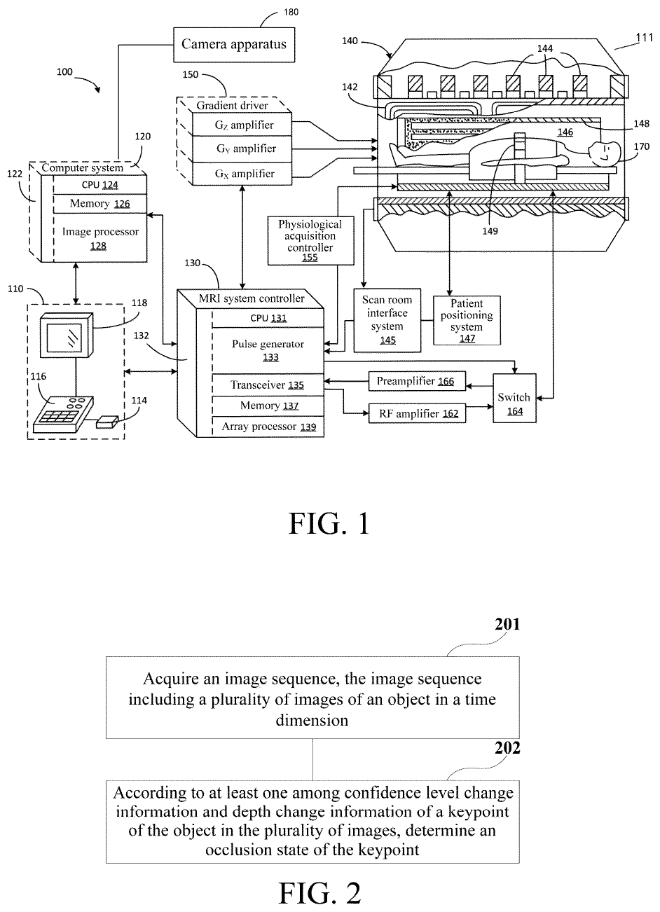

For ease of understanding, FIG. 1 is a schematic diagram of a magnetic resonance imaging (MRI) system 100 according to an embodiment of the present application.

The MRI system 100 includes a scanning unit 111. The scanning unit 111 is used to perform a magnetic resonance scan of an object (e.g., a human body) 170 to generate image data of a region of interest of the object 170, where the region of interest may be a pre-determined anatomical site or anatomical tissue.

The operation of the MRI system 100 is controlled by an operator workstation 110. The operator workstation 110 includes an input device 114, a control panel 116, and a display 118. The input device 114 may be a joystick, a keyboard, a mouse, a trackball, a touch-activated screen, voice control, or any similar or equivalent input device. The control panel 116 may include a keyboard, a touch-activated screen, voice control, a button, a slider, or any similar or equivalent control device. The operator workstation 110 is coupled to and in communication with a computer system 120 that enables an operator to control the generation and display of images on the display 118. The computer system 120 includes various components that communicate with one another via an electrical and/or data connection module 122. The connection module 122 may employ a direct wired connection, a fiber optic connection, a wireless communication link, etc. The computer system 120 may include a central processing unit (CPU) 124, a memory 126, and an image processor 128. In some implementations, the image processor 128 may be replaced by medical imaging functions implemented in the CPU 124. The computer system 120 may be connected to an archive media device, a persistent or backup memory, or a network. The computer system 120 may be coupled to and in communication with a separate MRI system controller 130.

The MRI system controller 130 includes a set of components that communicate with one another via an electrical and/or data connection module 132. The connection module 132 may employ a direct wired connection, a fiber optic connection, a wireless communication link, etc. The MRI system controller 130 may include a CPU 131, a sequence pulse generator (also known as a pulse generator) 133 in communication with the operator workstation 110, a transceiver (also known as an RF transceiver) 135, a memory 137, and an array processor 139.

In some implementations, the sequence pulse generator 133 may be integrated into a resonance assembly 140 of the scanning unit 111 of the MRI system 100. The MRI system controller 130 may receive a command from the operator workstation 110, and is coupled to the scanning unit 111 to indicate an MRI scanning sequence to be performed during an MRI scan, so as to be used to control the scanning unit 111 to perform the flow of the aforementioned magnetic resonance scan. The MRI system controller 130 is further coupled to a gradient driver system (also known as gradient driver) 150 and is in communication therewith, and the gradient driver system is coupled to a gradient coil assembly 142 to generate a magnetic field gradient during an MRI scan.

The sequence pulse generator 133 may further receive data from a physiological acquisition controller 155 that receives signals from a plurality of different sensors (e.g., electrocardiogram (ECG) signals from electrodes attached to a patient, etc.), the sensors being connected to the object or patient 170 undergoing an MRI scan. The sequence pulse generator 133 is coupled to and in communication with a scan room interface system 145 that receives signals from various sensors associated with the state of the resonance assembly 140. The scan room interface system 145 is further coupled to and in communication with a patient positioning system 147 that sends and receives signals to control a patient table to move to a desired position to perform the MRI scan.

The MRI system controller 130 provides gradient waveforms to the gradient driver system 150, and the gradient driver system includes Gₓ (x direction), G_{y} (y direction), and G_{z} (z direction) amplifiers, etc. Each of the Gₓ, G_{y}, and G_{z} gradient amplifiers excites a corresponding gradient coil in the gradient coil assembly 142, so as to generate a magnetic field gradient used to spatially encode an MR signal during an MRI scan. The gradient coil assembly 142 is disposed within the resonance assembly 140, and the resonance assembly further includes a superconducting magnet having a superconducting coil 144, which, in operation, provides a static uniform longitudinal magnetic field B₀ throughout a cylindrical imaging volume 146. The resonance assembly 140 further includes an RF body coil 148, which, in operation, provides a transverse magnetic field B₁, and the transverse magnetic field B₁ is substantially perpendicular to B₀ throughout the entire cylindrical imaging volume 146. The resonance assembly 140 may further include an RF surface coil 149 for imaging different anatomical structures of the patient undergoing the MRI scan. The RF body coil 148 and the RF surface coil 149 may be configured to operate in a transmit and receive mode, a transmit mode, or a receive mode.

The x direction may also be referred to as a frequency encoding direction or a kₓ direction in the k-space, the y direction may be referred to as a phase encoding direction or a k_{y} direction in the k-space, and the z direction may be referred to as a layer surface selection (layer selection) direction. Gₓ can be used for frequency encoding or signal readout, and is generally referred to as a frequency encoding gradient or a readout gradient. G_{y} can be used for phase encoding, and is generally referred to as a phase encoding gradient. G_{z} can be used for slice (layer) position selection to acquire k-space data. It should be noted that the layer selection direction, phase encoding direction, and frequency encoding direction may be modified according to actual requirements.

The object or patient 170 of the MRI scan may be positioned within the cylindrical imaging volume 146 of the resonance assembly 140. The transceiver 135 in the MRI system controller 130 generates RF excitation pulses amplified by an RF amplifier 162, and provides the same to the RF body coil 148 through a transmit/receive switch (also known as T/R switch or switch) 164.

As described above, the RF body coil 148 and the RF surface coil 149 may be used to transmit RF excitation pulses and/or receive resulting MR signals from the patient undergoing the MRI scan. The MR signals emitted by excited nuclei in the patient of the MRI scan may be sensed and received by the RF body coil 148 or the RF surface coil 149 and sent back to a preamplifier 166 through the T/R switch 164. The T/R switch 164 may be controlled by a signal from the sequence pulse generator 133 to electrically connect the RF amplifier 162 to the RF body coil 148 in the transmit mode and to connect the preamplifier 166 to the RF body coil 148 in the receive mode. The T/R switch 164 may further enable the RF surface coil 149 to be used in the transmit mode or the receive mode.

In some embodiments, the MR signals sensed and received by the RF body coil 148 or the RF surface coil 149 and amplified by the preamplifier 166 are stored in the memory 137 for post-processing as a raw k-space data array. A reconstructed magnetic resonance image may be obtained by transforming/processing the stored raw k-space data.

In some implementations, the MR signals sensed and received by the RF body coil 148 or the RF surface coil 149 and amplified by the preamplifier 166 are demodulated, filtered, and digitized in a receiving portion of the transceiver 135, and transmitted to the memory 137 in the MRI system controller 130. For each image to be reconstructed, the data is rearranged into separate k-space data arrays, and each of said separate k-space data arrays is input into the array processor 139, which is operated to transform the data into an array of image data by Fourier transform.

The array processor 139 uses transform methods, most commonly Fourier transform, to create images from the received MR signals. These images are transmitted to the computer system 120 and stored in the memory 126. In response to commands received from the operator workstation 110, the image data may be stored in a long-term memory, or may be further processed by the image processor 128 and transmitted to the operator workstation 110 for presentation on the display 118.

In various implementations, components of the computer system 120 and the MRI system controller 130 may be implemented on the same computer system or on a plurality of computer systems. It should be understood that the MRI system 100 shown in FIG. 1 is intended for illustration. Suitable MRI systems may include more, fewer, and/or different components.

The MRI system controller 130 and the image processor 128 may separately or collectively include a computer processor and a storage medium. The storage medium records predetermined data processing programs to be executed by the computer processor. For example, the storage medium may store programs used to implement scanning processing (such as a scan flow and an imaging sequence), image reconstruction, medical imaging, etc. For example, the storage medium may store a program used to implement the magnetic resonance imaging method according to the embodiments of the present invention. The storage medium may include, for example, a ROM, a floppy disk, a hard disk, an optical disk, a magneto-optical disk, a CD-ROM, or a non-volatile memory card.

The MRI system 100 further includes a camera apparatus 180. The camera apparatus 180 employs the principle of optical imaging to acquire information such as visual and morphological information of an object under detection. The camera apparatus 180 may be a camera, a video camera, or the like. In general, the camera apparatus 180 may be installed near an examining table so that image information of the object under detection can be maximally collected in a non-contact manner. The image information may be used to assist with medical imaging operations. For example, positioning information of the object under detection may be determined using image information acquired by the camera apparatus 180, so as to optimize the positioning process of the object under detection.

The inventors have found that since the object under detection is covered with an occlusion, it is necessary to determine an occlusion range of the object under detection, so as to determine positioning information according to the occlusion range. However, existing occlusion detection methods have certain limitations. For example, since there are a large number of different types and patterns of occlusions in the MRI system, a great deal of effort is required to collect and label training data for the occlusions so as to train a detection model according to the training data. Furthermore, if a new occlusion is introduced, training data needs to be re-collected and labeled to train a detection model capable of detecting the new occlusion. The detection model obtained in the above manner depends on the shape, color, pattern, or the like of the occlusion, and thus is applicable to limited scenarios.

In view of at least one of the above problems, the embodiments of the present application provide an occlusion detection method for medical imaging, a medical imaging method, and a medical imaging system.

Description is provided below in conjunction with the embodiments.

The embodiments of the present application provide an occlusion detection method for medical imaging. FIG. 2 is a schematic diagram of an occlusion detection method for medical imaging according to an embodiment of the present application. As shown in FIG. 2, the method includes: at step 201, acquiring an image sequence, the image sequence including a plurality of images of an object in a time dimension; and at step 202, according to at least one among confidence level change information and depth change information of a keypoint of the object in the plurality of images, determining an occlusion state of the keypoint.

According to the above embodiment, when an occlusion state of a keypoint of an object under detection is being determined, by taking into consideration a confidence level change or a depth value change in the keypoint caused by covering the object with an occlusion, the occlusion state of the keypoint can be determined according to the confidence level change or the depth value change in the keypoint, thereby improving the accuracy and reliability of the occlusion state. In addition, the foregoing manner of determining the occlusion state does not depend on the shape, color, pattern, or the like of the occlusion, and has wide applicability.

In some embodiments, the image sequence can be generated by the foregoing camera apparatus 180. The image sequence includes a plurality of images in the time dimension. In other words, the plurality of images may be images acquired at different time points.

In some embodiments, the image sequence may include various types of image sequences. For example, the image sequence includes a color image sequence, or a depth image sequence, or a color image sequence and a depth image sequence corresponding to each other in the time dimension. The color image sequence includes a plurality of color images, and the depth image sequence includes a plurality of depth images.

In other words, the images in the image sequence may include various types of images. For example, the images may include color images, or depth images, or color images and depth images corresponding to each other in the time dimension. The color images and the depth images corresponding to each other in the time dimension may refer to color images and depth images acquired at the same time point.

In some embodiments, the color images may include a plurality of pixel points, and the value of each pixel point may include the value of each color component. The color components may include red, green and blue (RGB) components and the like.

In some embodiments, the depth images may include a plurality of pixel points, and the value of each pixel point may include a depth value of the pixel. The depth value may be a distance between the object under detection and a reference plane, or the like. The reference plane is, for example, an image capture plane of the camera apparatus 180.

In some embodiments, when the image sequence includes a color image sequence, the confidence level change information of the keypoint may be determined from a plurality of color images in the image sequence. Since the color images can provide more image information, determining confidence level change information of the keypoint according to the color images can improve the accuracy of the confidence level change information. But the present application is not limited thereto, and the confidence level change information may also be determined according to other images. For example, the confidence level change information may also be determined according to the depth images in the depth image sequence.

In some embodiments, the confidence level change information may be change information of confidence levels of keypoints of the same type in a first image and a second image among the plurality of images, wherein the second image follows the first image in the time dimension.

The confidence level change information may be in various forms. For example, the confidence level change information may be at least one among the difference and the ratio between the confidence levels of the keypoints of the same type in the first image and the second image.

In some embodiments, the keypoints of the object under detection may be, for example, feature points that are related to body parts (anatomical structures) of the object under detection and can be detected in the image. The types of the keypoints may include at least one of the following: head, nose, left eye, right eye, left ear, right ear, neck, left shoulder, right shoulder, left elbow, right elbow, left wrist, right wrist, chest, abdomen, left hip, right hip, left knee, right knee, left ankle, right ankle, or the like. The present application is not limited thereto, and the types of the keypoints may also include other content.

In some embodiments, the confidence level of the keypoint may be in the form of a probability. For example, the confidence level of the keypoint may represent the probability that the actual position of the keypoint is located at the detection position. The higher the confidence level of the keypoint, the higher the probability that the keypoint is located at the detection position. The lower the confidence level of the keypoint, the lower the probability that the keypoint is located at the detection position. The present application is not limited thereto, and the confidence level information of the keypoint may be in other forms or has other definitions.

In some embodiments, the keypoints and the confidence levels may be generated by performing keypoint recognition on the images by means of a deep learning model. The deep learning model may be a convolutional neural network model, a deep belief network model, a stacked auto-encoder network model, and the like. An input of the deep learning model may be an image in an image sequence, and an output of the deep learning model may include at least one of the following: keypoints (position information, type information, and the like), confidence level information, and the like. For the specific manner of performing keypoint recognition using the deep learning model, reference can be made to the related art, which will not be further described here.

In some embodiments, the position information of the keypoint may be represented by pixel positions in the image. But the present application is not limited thereto, and the position information of the keypoint may be represented in other manners.

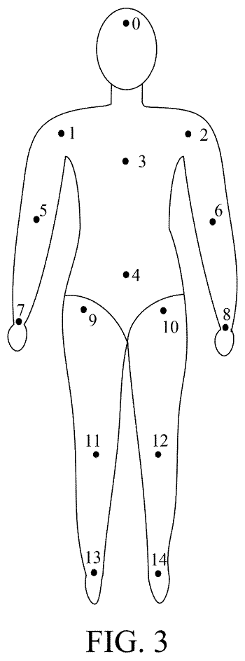

FIG. 3 is a schematic diagram of keypoints according to an embodiment of the present application. As shown in FIG. 3, a deep learning model may detect 16 keypoints of the human body. For example, the 16 keypoints are head keypoint 0, right shoulder keypoint 1, left shoulder keypoint 2, chest keypoint 3, abdomen keypoint 4, right elbow keypoint 5, left elbow keypoint 6, right wrist keypoint 7, left wrist keypoint 8, right hip keypoint 9, left hip keypoint 10, right knee keypoint 11, left knee keypoint 12, right ankle keypoint 13, left ankle keypoint 14, and neck keypoint 15, respectively. Information of the 16 keypoints may be represented by position information of the keypoints, type information of the keypoints, and the like. Furthermore, each of the 16 keypoints corresponds to one piece of confidence level information.

In some embodiments, when the image sequence includes a depth image sequence, the depth change information of the keypoint may be determined according to a plurality of depth images.

In some embodiments, the depth change information of the keypoint may be change information of depths of keypoints of the same type in a first image and a second image among the plurality of images.

The depth change information may be in various forms. For example, the depth change information may include at least one among the difference and the ratio between the depths of the keypoints of the same type in the first image and the second image.

A specific manner of determining an occlusion state of a keypoint according to confidence level change information of the keypoint will be exemplarily described below.

In some embodiments, when a keypoint in the second image has a confidence level less than that of a keypoint of the same type in the first image by a first value, and when the first value is greater than a first threshold, said keypoint is determined as an occluded keypoint.

In some embodiments, the first image may be an image adjacent to the second image in the time dimension. For example, the image sequence includes N images. Take an (i+1)^{th} image as the second image as an example, the first image is an i^{th} image, where i is greater than or equal to 1, and is less than or equal to N−1.

The present application is not limited thereto. The first image may also be an image in which keypoints in at least a partial region of the object under detection are not occluded. In other words, the image sequence includes an image in which keypoints in at least a partial region of the object under detection are not occluded, whereby the image can serve as a first image (reference image) for confidence level comparison. The first image may be determined according to information inputted by a user. For example, the information inputted by the user directly indicates the first image. Alternatively, the information inputted by the user is a first time point at which the object under detection is covered with an occlusion. In this case, an image before the first time point can be selected as the first image from the image sequence, and so on.

In the following, a specific manner of determining an occlusion state will be exemplarily described by using an example in which a deep learning model performs detection on the 16 keypoints shown in FIG. 3 and the object under detection in the first image is not covered with an occlusion.

Table 1 shows the confidence levels of the keypoints in the first image. As shown in Table 1, since the object under detection in the first image is not covered with an occlusion, the confidence levels of the keypoints outputted by the deep learning model are high.

TABLE 1
Confidence Levels of Keypoints in First Image

| 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| 88 | 83 | 77 | 53 | 53 | 59 | 59 | 80 | 73 | 57 | 53 | 55 | 51 | 78 | 73 | 53 |

The first row of Table 1 shows the number of each keypoint, and the second row of Table 1 shows the confidence level of each keypoint (the confidence level is in the form of a percentage, for example, the confidence level of head keypoint 0 is 88%).

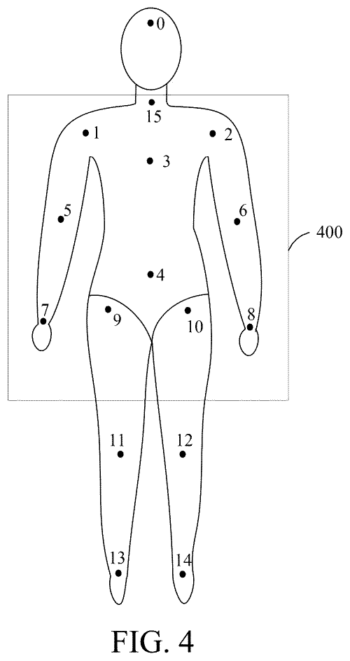

FIG. 4 is a schematic diagram of the occlusion state of keypoints according to an embodiment of the present application. As shown in FIG. 4, in the second image, a partial region of the object under detection is covered with a blanket 400. Table 2 shows the confidence levels of the keypoints in the second image. As shown in Table 2, since the partial region of the object under detection is covered with the blanket, the keypoints corresponding to the partial region have reduced confidence levels or are not detected, and a keypoint which is not detected has a confidence level of 0 or is not present.

TABLE 2
Confidence Levels of Keypoints in Second Image

| 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| 88 | 30 | 23 | 23 | 23 | 13 | 0 | 0 | 0 | 34 | 26 | 37 | 32 | 68 | 69 | 23 |

The first row of Table 2 shows the number of each keypoint, and the second row of Table 2 shows the confidence level of each keypoint.

After determining the confidence levels of the keypoints in the first image and the second image, the confidence level of each keypoint in the first image is subtracted from the confidence level of the corresponding keypoint in the second image to obtain confidence level change information. Table 3 shows the confidence level change information of the second image relative to the first image. As shown in Table 3, the confidence levels of right shoulder keypoint 1, left shoulder keypoint 2, chest keypoint 3, abdomen keypoint 4, right elbow keypoint 5, left elbow keypoint 6, right wrist keypoint 7, left wrist keypoint 8, right hip keypoint 9, left hip keypoint 10, and neck keypoint 15 are reduced, and are all reduced by over 20%. Therefore, the occlusion state of right shoulder keypoint 1, left shoulder keypoint 2, chest keypoint 3, abdomen keypoint 4, right elbow keypoint 5, left elbow keypoint 6, right wrist keypoint 7, left wrist keypoint 8, right hip keypoint 9, left hip keypoint 10, and neck keypoint 15 in the second image is “occluded”.

TABLE 3
Confidence Levels of Keypoints in Second Image

| 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| 0 | −53 | −54 | −30 | −30 | −46 | −59 | −80 | −73 | −23 | −27 | −18 | −19 | −10 | −4 | −30 |

The first row in Table 3 shows the number of each keypoint, and the second row in Table 3 shows the confidence level change information of each keypoint.

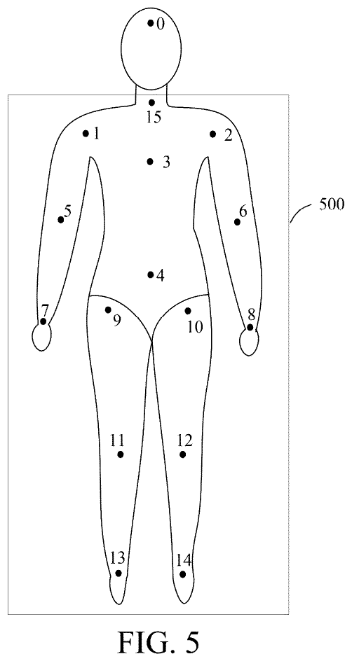

FIG. 5 is another schematic diagram of the occlusion state of keypoints according to an embodiment of the present application. As shown in FIG. 5, in the second image, most regions of the object under detection are covered with a blanket 500. Table 4 shows the confidence levels of the keypoints in the second image. As shown in Table 4, since most regions of the object under detection are covered with the blanket, most of the keypoints are not detected.

TABLE 4
Confidence Levels of Keypoints in Second Image

| 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| 88 | 16 | 0 | 0 | 0 | 0 | 0 | 0 | 0 | 0 | 0 | 0 | 0 | 0 | 0 | 0 |

The first row of Table 4 shows the number of each keypoint, and the second row of Table 4 shows the confidence level of each keypoint.

As shown in Table 4, except for the head keypoint, the confidence levels of the other 15 keypoints decrease by over 20%. Therefore, the occlusion state of the 15 keypoints other than the head keypoint in the second image is “occluded”.

In some embodiments, a third image and a fourth image are present in the image sequence, where the occlusion state of some keypoints in the third image is determined as “occluded”, and the fourth image follows the third image in the time dimension. If the confidence level of the keypoint in the fourth image is increased by a third value with respect to the confidence level of the keypoint of the same type in the third image, and if the third value is greater than a third threshold, the occlusion state of the keypoint in the fourth image can be determined as “unoccluded”.

The third image and the fourth image may be images adjacent to each other in the time dimension. Alternatively, the occlusion state of at least some keypoints in the third image is “occluded”.

The third threshold may be a value the same as the first threshold, but the present application is not limited thereto. The third threshold may also be a value different from the first threshold.

For example, the occlusion state of an abdomen keypoint in the third image is “occluded”, and the confidence level of the abdomen keypoint is 23%. If the confidence level of an abdomen keypoint in the fourth image is 78%, and if the confidence level of the abdomen keypoint in the fourth image is increased with respect to the confidence level of the abdomen keypoint in the third image by 55%, which is 20% greater than the third threshold, then the occlusion state of the abdomen keypoint in the fourth image can be determined as “unoccluded”.

A specific manner of determining an occlusion state of a keypoint according to depth change information of the keypoint will be exemplarily described below.

In some embodiments, when a keypoint in the second image has a depth less than that of a keypoint of the same type in the first image by a second value, and when the second value is greater than a second threshold, said keypoint is an occluded keypoint.

In some embodiments, the first image may be an image adjacent to the second image in the time dimension, but the present application is not limited thereto. The first image may also be an image in which keypoints in at least a partial region of the object under detection are not occluded. In other words, the image sequence includes an image in which keypoints of at least a partial region of the object under detection are not occluded, whereby the image can serve as a first image (reference image) for depth value comparison.

In some embodiments, when determining the occlusion state of a keypoint according to depth change information of the keypoint, position information of the keypoint can be determined first, and then the depth change information of the keypoint can be determined according to the position information of the keypoint. In this way, the computing amount can be reduced, and the computing power can be saved. But the present application is not limited thereto. It is also possible to determine depth change information of each pixel within the entire image range first, and then to determine depth change information of a keypoint according to position information of the keypoint.

In some embodiments, the keypoint in the second image can be determined in various manners. The manner of determining the keypoint in the second image is exemplarily described by using an example in which the image sequence includes a depth image sequence and the first image and the second image are depth images.

In some embodiments, the keypoint in the second image may be generated by performing keypoint recognition on the second image by means of a deep learning model.

In some embodiments, the keypoint in the second image may be generated by performing keypoint recognition on a color image corresponding to the second image by means of a deep learning model. Specifically, coordinate information of a keypoint in the color image is taken as or is converted to coordinate information of a keypoint of the same type in the second image.

In some embodiments, the keypoint in the second image may be generated by means of a deep learning model by performing keypoint recognition on the second image and the color image respectively, and performing weighted averaging on recognition results. For example, the coordinates of the keypoints of the same type in the second image and the corresponding color image are weighted according to the confidence levels, and the result of weighting is taken as keypoint coordinates of the second image.

In some embodiments, the keypoint in the second image may be generated by performing keypoint recognition on a reference image in the image sequence by means of a deep learning model. Specifically, coordinate information of a keypoint in the reference image is taken as or converted to coordinate information of a keypoint of the same type in the second image. The reference image may be an image in which keypoints in at least a partial region of the object under detection are not occluded. In some embodiments, the reference image may be the first image.

In some embodiments, after the keypoint in the second image is determined, the depth of the keypoint can be determined in various manners.

For example, the depth of the keypoint is the depth of the keypoint itself. For example, a pixel point in the second image is determined according to position information of the keypoint in the second image, and a depth value of the pixel point is taken as the depth of the keypoint. In this way, the depth of the keypoint can be determined in a simple manner.

As another example, the depth of the keypoint is determined according to the depths of pixels within a preset region of the image that includes the keypoint. Therefore, the reliability of the depth of the keypoint can be improved. For example, when a hole is present in a coil covering the object under detection and the position of the hole coincides with the position of a keypoint, the depth of the keypoint does not change, and if the occlusion state is determined using the depth of the keypoint itself, the keypoint may be determined as unoccluded. However, since the anatomical structure corresponding to the keypoint is covered by the coil, it is more reasonable to determine the keypoint as occluded. By considering the depths of other pixels around the keypoint during determination of the depth of the keypoint, the reliability of the depth of the keypoint can be improved.

The keypoint may be located at the center of the preset region, but the present application is not limited thereto. The keypoint may also be at another position in the preset region.

When the depth of the keypoint is determined according to the depths of pixels within the preset region, the depth of the keypoint may be at least one of the following: an average value of the depths of all the pixels within the preset region; a weighted average value of the depths of all the pixels within the preset region; or a depth of the keypoint obtained by performing convolutional processing on the depths of the pixels within the preset region.

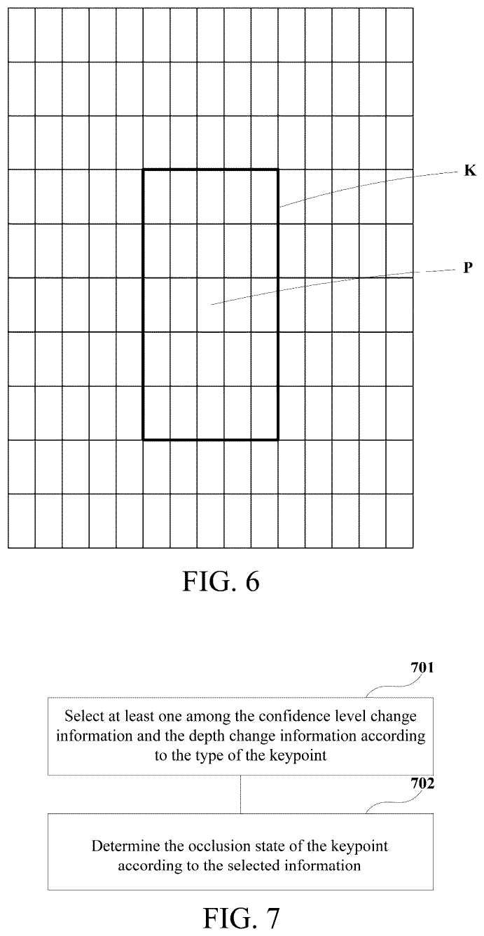

FIG. 6 is a schematic diagram of a preset region according to an embodiment of the present application. As shown in FIG. 6, a keypoint P may be used as the center to select a preset region K in a second image. The preset region K includes, for example, 5*5 pixels.

An average value of depth values of the 25 pixels may be taken as a depth value of the keypoint P.

Alternatively, weighted averaging calculation may be performed on the depth values of the 25 pixels, and the result of the weighted averaging serves as the depth value of the keypoint P. The weight of each pixel in the preset region can be set in various manners. For example, the weight of each pixel is determined according to a distance between each pixel and the keypoint P. For example, the weight of the keypoint P may be set to 60%, the weights of 8 pixels around the keypoint P may be set to 30%, and the weights of the outermost 18 pixels may be set to 10%.

Alternatively, a convolution operation may be performed on the depths of the pixels in the preset region using a convolution kernel, and the result of the convolution operation is taken as the depth of the keypoint P. The size of the convolution kernel is, for example, the size of the preset region.

In some embodiments, the second threshold for determining the occlusion state of the keypoint may be a value related to a depth value error of the camera apparatus. The depth value error is, for example, a depth change value that cannot be identified by the camera apparatus. The depth value error is, for example, 2 cm.

The second threshold may be a value greater than or equal to the depth value error of the camera apparatus. For example, the second threshold may be 3 cm or the like.

In some embodiments, a fifth image and a sixth image are present in the image sequence, where the occlusion state of some keypoints in the fifth image are determined as “occluded”, and the sixth image follows the fifth image in the time dimension. If the depth value of the keypoint in the sixth image is increased by a fourth value with respect to the depth value of the keypoint of the same type in the fifth image and if the fourth value is greater than a fourth threshold, the occlusion state of the keypoint in the sixth image may be determined as “unoccluded”.

The fifth image and the sixth image may be images adjacent to each other in the time dimension. Alternatively, the occlusion state of at least some keypoints in the fifth image may be “occluded”.

The fourth threshold may be a value the same as the third threshold, but the present application is not limited thereto. The fourth threshold may also be a value different from the third threshold.

For example, the occlusion state of an abdomen keypoint in the fifth image is “occluded”, and the depth value of the abdomen keypoint is 70 cm. If the confidence level of an abdomen keypoint in the sixth image is 78 cm, and if the depth value of the abdomen keypoint in the sixth image is increased with respect to the depth value of the abdomen keypoint in the fifth image by 8 cm, which is 3 cm greater than the fourth threshold, then the occlusion state of the abdomen keypoint in the sixth image can be determined as “unoccluded”.

In some embodiments, the occlusion state of the keypoint may be determined according to both the confidence level change information and the depth change information. For example, the occlusion state of the keypoint is determined as “occluded” when Condition 1 and Condition 2 are satisfied. Condition 1: The confidence level of the keypoint in the second image is less than the confidence level of the keypoint of the same type in the first image by a first value, and the first value is greater than a first threshold. Condition 2: The depth of the keypoint in the second image is less than the depth of the keypoint of the same type in the first image by a second value, and the second value is greater than a second threshold.

In some embodiments, the occlusion states of different types of keypoints may be determined in the same manner. For example, for all keypoints, the occlusion states of the keypoints are determined according to both the confidence level change information and the depth change information. Alternatively, for all keypoints, the occlusion states of the keypoints are determined according to the confidence level change information. Alternatively, for all keypoints, the occlusion states of the keypoints are determined according to the depth change information.

In some embodiments, an appropriate manner of determining the occlusion state of a keypoint may be selected according to the type of the keypoint. FIG. 7 is a schematic diagram of the implementation of step 202 according to an embodiment of the present application. As shown in FIG. 7, step 202 includes: at step 701, selecting at least one among the confidence level change information and the depth change information according to the type of the keypoint; and at step 702, determining the occlusion state of the keypoint according to the selected information.

Since the confidence level outputted by the deep learning model may not greatly decrease when the area of the occlusion is small, the manner of determining the occlusion state according to the confidence level change information is more suitable when the area of the occlusion is large. For example, for a torso keypoint (abdomen, chest, or the like), the area of the occlusion is typically large, and the confidence level change information may be selected to determine the occlusion state of the torso keypoint.

For example, for a limb keypoint (elbow, wrist, knee, ankle, or the like), the area of the coil is typically small, and the depth change information may be selected to determine the occlusion state of the limb keypoint.

For example, for a head keypoint, both the confidence level change information and the depth change information may be selected to determine the occlusion state of the head keypoint.

According to the above embodiment, when an occlusion state of a keypoint of an object under detection is being determined, by taking into consideration a confidence level change or a depth value change in the keypoint caused by covering the object with an occlusion, the occlusion state of the keypoint can be determined according to the confidence level change or the depth value change in the keypoint, thereby improving the accuracy and reliability of the occlusion state. In addition, the foregoing manner of determining the occlusion state does not depend on the shape, color, pattern, or the like of the occlusion, and has wide applicability.

The embodiments of the present application further provide an occlusion detection apparatus for medical imaging, and the same content as that of the embodiments of the first aspect is not repeated herein.

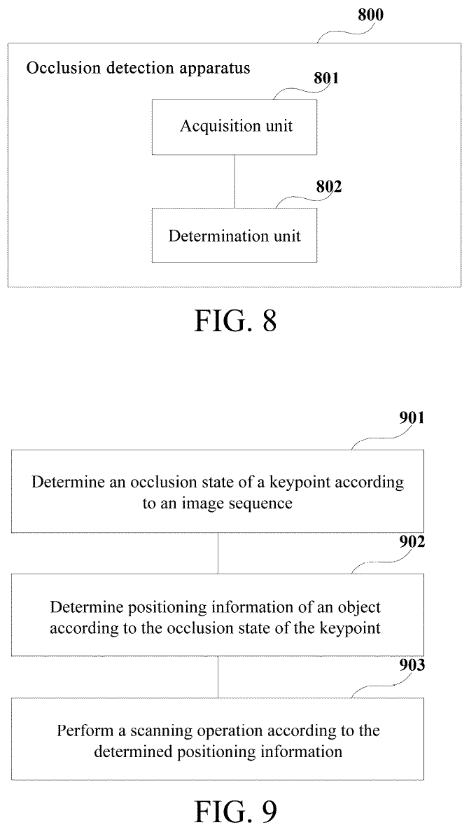

FIG. 8 is a schematic diagram of an occlusion detection apparatus for medical imaging according to an embodiment of the present invention. As shown in FIG. 8, the occlusion detection apparatus 800 for medical imaging includes: an acquisition unit 801, which acquires an image sequence including a plurality of images of an object in a time dimension; and a determination unit 802, which, according to at least one among confidence level change information and depth change information of a keypoint of the object in the plurality of images, determines an occlusion state of the keypoint.

In some embodiments, the confidence level change information is change information of confidence levels of keypoints of the same type in a first image and a second image among the plurality of images, where the second image follows the first image in the time dimension.

In some embodiments, the confidence level change information includes at least one among the difference and the ratio between the confidence levels of the keypoints of the same type in the first image and the second image.

In some embodiments, when a keypoint in the second image has a confidence level less than that of a keypoint of the same type in the first image by a first value, and when the first value is greater than a first threshold, said keypoint is an occluded keypoint.

In some embodiments, the keypoints and the confidence levels are generated by performing keypoint recognition on the images by means of a deep learning model.

In some embodiments, the depth change information is change information of depths of keypoints of the same type in a first image and a second image among the plurality of images, where the second image follows the first image in the time dimension.

In some embodiments, the depth change information includes at least one among the difference and the ratio between the depths of the keypoints of the same type in the first image and the second image.

In some embodiments, when a keypoint in the second image has a depth less than that of a keypoint of the same type in the first image by a second value, and when the second value is greater than a second threshold, said keypoint is an occluded keypoint.

In some embodiments, the depth of the keypoint is the depth of the keypoint itself. Alternatively, the depth of the keypoint is determined according to depths of pixels within a preset region in an image, and the keypoint is located within the preset region.

In some embodiments, the keypoint is located at the center of the preset region.

In some embodiments, the depth of the keypoint is at least one of the following: a) an average value of the depths of the pixels within the preset region; b) a weighted average value of the depths of the pixels within the preset region; or c) a depth of the keypoint obtained by performing convolutional processing on the depths of the pixels within the preset region.

In some embodiments, the first image is an image adjacent to the second image in the time dimension. Alternatively, the first image is an image in which keypoints in at least a partial region of the object are not occluded.

In some embodiments, the determination unit 802 selects at least one among the confidence level change information and the depth change information according to the type of the keypoint, and determines the occlusion state of the keypoint according to the selected information.

In some embodiments, the image sequence includes a color image sequence, a depth image sequence, or a color image sequence and a depth image sequence corresponding to each other. The color image sequence includes a plurality of color images, and the depth image sequence includes a plurality of depth images. The confidence level change information is determined according to the plurality of color images, and the depth change information is determined according to the plurality of depth images.

It is worth noting that only the components or modules related to the present application are described above, but the present application is not limited thereto. The occlusion detection apparatus 800 for medical imaging may also include other components or modules, the specifics of which can be found in the relevant art.

For the sake of simplicity, FIG. 8 only exemplarily illustrates the connection relationship or signal direction between various components or modules, but it should be clear to those skilled in the art that various related technologies such as bus connection can be used. The various components or modules can be implemented by means of hardware such as a processor or a memory, etc. The embodiments of the present application are not limited thereto.

The above embodiments merely provide illustrative descriptions of the embodiments of the present application. However, the present application is not limited thereto, and appropriate variations may be made on the basis of the above embodiments. For example, each of the above embodiments may be used independently, or one or more among the above embodiments may be combined.

When an occlusion state of a keypoint of an object under detection is being determined, by taking into consideration a confidence level change or a depth value change in the keypoint caused by covering the object with an occlusion, the occlusion state of the keypoint can be determined according to the confidence level change or the depth value change in the keypoint, thereby improving the accuracy and reliability of the occlusion state. In addition, the foregoing manner of determining the occlusion state does not depend on the shape, color, pattern, or the like of the occlusion, and has good wide applicability.

The embodiments of the present application further provide a medical imaging method. FIG. 9 is a schematic diagram of a medical imaging method according to an embodiment of the present application. As shown in FIG. 9, the medical imaging method includes: at step 901, determining an occlusion state of a keypoint according to an image sequence; at step 902, determining positioning information of an object according to the occlusion state of the keypoint; and at step 903, performing a scanning operation according to the determined positioning information.

In step 901, the occlusion state of the keypoint may be determined according to the occlusion detection method for medical imaging in the foregoing embodiments. The content thereof is incorporated herein and will not be further described.

In some embodiments, in step 902, the occlusion state of the keypoint of the object is also considered when determining the positioning information of the object according to the image sequence, whereby the accuracy and reliability of the positioning information can be ensured.

The positioning information may be position information of the keypoint. In step 902, the positioning information can be determined according to the occlusion state in various manners. For example, for an occluded keypoint in an image, position information of a pre-occlusion keypoint of the same type is used as position information of the occluded keypoint.

In some embodiments, step 903 may include positioning a scan object according to the positioning information. For example, a region of interest to be imaged on a current object is determined, and a relative position between the object and the center of a scanning device is adjusted according to the positioning information, so as to align a coordinate center of the determined region of interest with a scanning center of an imaging device.

In some embodiments, step 903 further includes performing a scanning operation on the positioned scan object.

According to the above embodiments, since the occlusion state of a keypoint is determined using the occlusion detection method for medical imaging described in the above embodiments, the occlusion state of the keypoint has high accuracy and reliability. When positioning information is determined according to the occlusion state of the keypoint and a scanning operation is performed according to the positioning information, the accuracy and reliability of a scanning result can be ensured.

The embodiments of the present application further provide a medical imaging system. The configuration of the medical imaging system is as shown in FIG. 1, and similarities are not repeated here.

In some embodiments, unlike the foregoing medical imaging system in FIG. 1, the controller 130 is configured to perform the foregoing occlusion detection method for medical imaging, specifically comprising: acquiring an image sequence, the image sequence including a plurality of images of an object in a time dimension; and according to at least one among confidence level change information and depth change information of a keypoint of the object in the plurality of images, determining an occlusion state of the keypoint.

In some embodiments, the controller 130 (which may also be a processor) includes a computer processor and a storage medium. The storage medium records predetermined data processing programs to be executed by the computer processor. For example, the storage medium may store programs configured to implement scanning processing (for example, including waveform design/conversion, and the like), image reconstruction, medical imaging, and the like. For example, the storage medium may store a program configured to implement an occlusion detection method for medical imaging according to an embodiment of the present invention. The occlusion detection method for medical imaging includes: acquiring an image sequence, the image sequence including a plurality of images of an object in a time dimension; and according to at least one among confidence level change information and depth change information of a keypoint of the object in the plurality of images, determining an occlusion state of the keypoint. The specific implementations are as described above, and will not be described again here. The storage medium may include, for example, a ROM, a floppy disk, a hard disk, an optical disk, a magneto-optical disk, a CD-ROM, or a non-volatile memory card.

The present application is not limited thereto. The foregoing occlusion detection method for medical imaging may also be performed by other processors in the MRI system 100, or by a cloud processor.

In some embodiments, the controller 130 may also determine positioning information of an object according to the occlusion state of the keypoint.

In some embodiments, a scanning assembly may perform a scanning operation according to the positioning information determined by the controller 130. The scanning assembly may include a positioning assembly. The positioning assembly may position the scan object according to the positioning information. The positioning assembly is, for example, the patient positioning system 147 of the MRI system 100.

In some embodiments, the scanning assembly may further include a scanning unit 111. The scanning unit 111 performs a scanning operation on the positioned scan object.

According to the above embodiments, since an occlusion state of a keypoint is determined using the occlusion detection method for medical imaging described in the above embodiments, the occlusion state of the keypoint has high accuracy and reliability. When positioning information is determined according to the occlusion state of the keypoint and a scanning operation is performed according to the positioning information, the accuracy and reliability of a scanning result can be ensured.

The embodiments of the present application further provide a computer-readable program, which, when executed in a medical imaging system, causes a computer to perform, in the medical imaging system, the occlusion detection method for medical imaging according to the foregoing embodiments.

The embodiments of the present application further provide a storage medium having a computer-readable program stored therein, where the computer-readable program causes a computer to perform, in a medical imaging system, the occlusion detection method for medical imaging according to the foregoing embodiments.

The above apparatus and method of the present application can be implemented by hardware, or can be implemented by hardware in combination with software. The present application relates to a computer-readable program which, when executed by a logic component, causes the logic component to implement the foregoing apparatus or a constituent component, or causes the logic component to implement various methods or steps as described above. The present application further relates to a storage medium for storing the above program, such as a hard disk, a disk, an optical disk, a DVD, a flash memory, etc.

The method/apparatus described in view of the embodiments of the present application may be directly embodied as hardware, a software module executed by a processor, or a combination of the two. For example, one or more of the functional block diagrams and/or one or more combinations of the functional block diagrams shown in the drawings may correspond to either respective software modules or respective hardware modules of a computer program flow. The foregoing software modules may respectively correspond to the steps shown in the figures. The foregoing hardware modules can be implemented, for example, by firming the software modules using a field-programmable gate array (FPGA).

The software modules may be located in a RAM, a flash memory, a ROM, an EPROM, an EEPROM, a register, a hard disk, a portable storage disk, a CD-ROM, or any other form of storage medium known in the art. The storage medium may be coupled to a processor, so that the processor can read information from the storage medium and can write information into the storage medium. Alternatively, the storage medium may be a constituent component of the processor. The processor and the storage medium may be located in an ASIC. The software module may be stored in a memory of a mobile terminal, and may also be stored in a memory card that can be inserted into a mobile terminal. For example, if a device (such as a mobile terminal) uses a large-capacity MEGA-SIM card or a large-capacity flash memory device, the software modules can be stored in the MEGA-SIM card or the large-capacity flash memory apparatus.

One or more of the functional blocks and/or one or more combinations of the functional blocks shown in the accompanying drawings may be implemented as a general-purpose processor, a digital signal processor (DSP), an application-specific integrated circuit (ASIC), a field-programmable gate array (FPGA) or other programmable logic devices, discrete gate or transistor logic devices, a discrete hardware assembly, or any appropriate combination thereof for implementing the functions described in the present application. The one or more functional blocks and/or the one or more combinations of the functional blocks shown in the accompanying drawings may also be implemented as a combination of computing devices, such as a combination of a DSP and a microprocessor, multiple microprocessors, one or more microprocessors in communication combination with a DSP, or any other such configuration.

The present application is described above with reference to specific implementations. However, it should be clear to those skilled in the art that the foregoing description is merely illustrative and is not intended to limit the scope of protection of the present application. Various variations and modifications may be made by those skilled in the art according to the principle of the present application, and such variations and modifications also fall within the scope of the present application.

1. An occlusion detection method for medical imaging, characterized by comprising:
acquiring an image sequence, the image sequence comprising a plurality of images of an object in a time dimension; and
according to at least one among confidence level change information and depth change information of a keypoint of the object in the plurality of images, determining an occlusion state of the keypoint.

2. The method according to claim 1, wherein
the confidence level change information is change information of confidence levels of keypoints of the same type in a first image and a second image among the plurality of images, wherein the second image follows the first image in the time dimension.

3. The method according to claim 2, wherein
the confidence level change information comprises at least one among the difference and the ratio between the confidence levels of the keypoints of the same type in the first image and the second image.

4. The method according to claim 2, wherein
when a keypoint in the second image has a confidence level less than that of a keypoint of the same type in the first image by a first value, and when the first value is greater than a first threshold, said keypoint is an occluded keypoint.

5. The method according to claim 2, wherein
the keypoints and the confidence levels are generated by performing keypoint recognition on the images by means of a deep learning model.

6. The method according to claim 1, wherein
the depth change information is change information of depths of keypoints of the same type in a first image and a second image among the plurality of images, wherein the second image follows the first image in the time dimension.

7. The method according to claim 6, wherein
the depth change information comprises at least one among the difference and the ratio between the depths of the keypoints of the same type in the first image and the second image.

8. The method according to claim 6, wherein
when a keypoint in the second image has a depth less than that of a keypoint of the same type in the first image by a second value, and when the second value is greater than a second threshold, said keypoint is an occluded keypoint.

9. The method according to claim 6, wherein
the depth of the keypoint is determined according to depths of pixels within a preset region in an image, and the keypoint is located within the preset region.

10. The method according to claim 9, wherein
the keypoint is located at the center of the preset region.

11. The method according to claim 9, wherein
the depth of the keypoint is at least one of the following:
an average value of the depths of the pixels within the preset region;
a weighted average value of the depths of the pixels within the preset region; or
a depth of the keypoint obtained by performing convolutional processing on the depths of the pixels within the preset region.

12. The method according to claim 2, wherein
the first image is an image adjacent to the second image in the time dimension; or, the first image is an image in which keypoints in at least a partial region of the object are not occluded.

13. The method according to claim 1, wherein the according to at least one among confidence level change information and depth change information of a keypoint of the object in the plurality of images, determining an occlusion state of the keypoint comprises:
selecting at least one among the confidence level change information and the depth change information according to the type of the keypoint, and determining the occlusion state of the keypoint according to the selected information.

14. The method according to claim 1, wherein
the image sequence comprises a color image sequence, a depth image sequence, or a color image sequence and a depth image sequence corresponding to each other, the color image sequence comprises a plurality of color images, and the depth image sequence comprises a plurality of depth images,
the confidence level change information is determined according to the plurality of color images, and the depth change information is determined according to the plurality of depth images.

15. A medical imaging method, characterized by comprising:
determining an occlusion state of a keypoint on the basis of the method according to claim 1;
determining positioning information of an object according to the occlusion state of the keypoint; and
performing a scanning operation according to the determined positioning information.

16. A medical imaging system, characterized by comprising:
a controller, configured to perform the method according to any claim 1 to determine an occlusion state of a keypoint, and to determine positioning information of an object according to the occlusion state of the keypoint; and
a scanning assembly, which performs a scanning operation according to the determined positioning information.
